(19) United States
(12) Patent Application Publication
(10) Pub. No.: US 2015/0100885 A1
(43) Pub. Date: Apr. 9, 2015

(54) VIDEO STREAMING ON A MOBILE DEVICE

(71) Applicants: Morgan James Riley, Kansas City, MO (US); Frederick Wilson Rich, IV, Richmond, TX (US)

(72) Inventors: Morgan James Riley, Kansas City, MO (US); Frederick Wilson Rich, IV, Richmond, TX (US)

(21) Appl. No.: 14/507,776

(22) Filed: Oct. 6, 2014

Related U.S. Application Data
(60) Provisional application No. 61/887,069, filed on Oct. 4, 2013.

(51) Int. Cl. G06F 3/0484; G06F 3/0488; H04M 1/725

(52) U.S. Cl. CPC G06F 3/04842; H04M 1/72583; G06F 3/0488
USPC 715/720

(57) ABSTRACT

A video streaming system for playback of videos, including: a touch screen display defining a playback window; a processor; and non-transitory computer-readable media including instruction that when executed by the processor cause it to: play one or more videos from a current channel of two or more channels, wherein each channel is a simultaneously available but different feed of videos, and wherein the two or more channels are ordered such that for each channel defines at least one of a previous channel and a next channel; receive a directional input through the user interface; determine whether the user has imparted a predetermined gesture on the touch screen display within the playback window along one of a horizontal axis and a vertical axis defined by an orientation of the one or more videos; and if predetermined gesture is along the vertical axis, updating the current channel of the video media.

### CROSS-REFERENCE TO RELATED APPLICATIONS

This application incorporates by reference and claims benefit to U.S. Provisional Patent Application No. 61/887,069 filed Oct. 4, 2013.

### BACKGROUND OF THE INVENTION

The present subject matter relates generally to systems and methods for video streaming on a mobile device. More specifically, the present invention relates to mobile devices that may receive streaming video channels that may be consumed by users in a manner intuitive to users accustomed to television, and relates to systems and methods for generating streaming video channels to mobile devices.

Mobile device users are increasingly using their mobile devices to enjoy streaming video. Previous user interfaces for streaming video on mobile devices were often difficult to navigate, and discovery of videos of interest has been equally difficult. Finding content has often required searching by typing on cramped mobile keypads and virtual keyboards.

Previous mobile video interfaces have been based on web-based approaches to finding content, such as keyword searching, following links, user-curated collections, etc. Upon completion of a video, these interfaces often returned users to web-based or web-like navigation pages.

Further, mobile devices are evolving in form factors and manner of use. For example, it has become common to stream video from a mobile device to a television. Additionally, some mobile devices are of sufficient size to be enjoyed by multiple users, in the manner of a television set. In these new form factors and manners of use, previous web-based user interfaces are cumbersome and difficult-to-use. Thus, there is a need for simple, easy-to-use, intuitive user interfaces for navigating video content on a mobile device.

Accordingly, there is a need for a video streaming systems including user interfaces for navigating video content on a mobile device that use television-like content programming and controls, as described herein.

### BRIEF SUMMARY OF THE INVENTION

To meet the needs described above and others, the present disclosure provides video streaming systems for consuming streaming video that include simple, easy-to-use, intuitive user interfaces for navigating video content on a mobile device that includes television-like content programming and controls. The video streaming system may be provided as a device that includes the functionality described herein, or may be provided as a video streaming application executed on a mobile device of the user. The device may communicate with a server to accomplish the functionality described herein. The device may be a mobile device, smart tv, game console, set-top box, etc.

It is contemplated that mobile video users are generally experienced with interfaces from traditional media, such as television. When using a television, users view “channels” that include consecutive discrete video programs back-to-back with occasional interstitial advertising and network video segments. Channel programming on television has traditionally been centrally directed and lacks user control. To find interesting content, television users navigate television content by switching channels. Although television limits user choice in terms of the order of displaying content, it has remained a popular mechanism to consume video content due, in part, to its simplicity of use, predictability, and familiarity to users.

The video streaming system provides a video viewing experience that television users may find familiar and intuitive. In an embodiment, the video streaming system is a video streaming application that plays streaming videos organized into channels. Videos may include music videos, TV episodes, news videos, web clips, movies, etc. Like television, the channels of the video streaming system are generally ordered in a list. Thus users may easily move through the list by using “channel up” and “channel down” actions by performing associated gestures. To provide a more television-like appearance, the video streaming application may be adapted to preferably play videos in fullscreen, landscape mode. The video streaming system may include a user interface for displaying the videos. The user interface may be provided as a touch screen or a remotely controlled interface such as a television, computer monitor, etc.

As noted, like television, the video streaming application permits users to watch a stream of videos that are played consecutively and continuously. However, unlike television, channels do not need to be pre-programmed and may be generated on demand for each viewer from a pool of material. A remote server may assemble the channels from a library of video and stream the content to the video streaming system. The library of video may include third-party hosted content. For example, the library may include content hosted on web-based video services, such as Youtube or Vimeo. Between videos, a still image, or bump, may be shown while the next video is buffered.

A user may direct the video streaming system to perform various actions to control playback using gestures. For example, in an embodiment, a channel up action and a channel down action are provided to permit the user to move up and down through the list of channels. In a preferred embodiment, the user performing a swipe up gesture may trigger the channel up action. Likewise, the user performing a swipe down gesture may trigger the channel down action. In other embodiments, the channel up action and channel down action may be associated with alternative gestures, such as double finger swipes, swipe left, swipe right, etc., as will be recognized by those of ordinary skill in the art from the examples provided herein.

As another example, in an embodiment, a next action is provided to jump to the next video. In a preferred embodiment, a user may trigger a next action using a left swipe. In alternate embodiments, alternative gestures, such as double finger swipes, swipe left, swipe right, etc., may be used to trigger the next action, as will be recognized by those of ordinary skill in the art from the examples provided herein.

As a further example, in an embodiment, a focus action is provided to place the video streaming system in focus mode wherein playback centers around the media currently being viewed. For example, in focus mode, the application may show only videos from the particular artist or program that the current video is an episode of. Further, in other examples, other attributes of a video such as popularity, genre, actor, director, etc., may be used to select media for inclusion in playback during focus mode.

In a preferred embodiment, swiping right triggers the focus action and puts the video stream into focus mode. As an example of the focus mode in operation, if the current video is a music video from the user's favorite artist, the user may swipe right to put the application in focus mode and cause the application to play other music videos from the same artist after the completion of the current video. Likewise, if the current video is a favorite show of the user, the user may swipe right to put the application in focus mode and cause the application to play further episodes from the same program. In a preferred embodiment, to leave focus mode, the user may swipe left and the application will return to the channel being viewed when focus mode was activated. Further, in a preferred embodiment of the focus mode, the user may swipe right to bring up the next focus mode video. In other embodiments, other gestures may be used to trigger the focus mode, for example, a two-finger swipe gesture may be used to trigger the focus mode. When placed into focus mode, the frame may include a central channel ID that identifies that the video stream has been placed into focus mode.

A channel is assembled based on channel programming, or use a channel programming schedule, that determines videos for playback based on the channel theme. The programming for a channel may be provided as a filter or a script that selects videos from a video list based on video metadata. Video metadata may include: previous views by the user, views by other users, video tags, title, program, subject, artist, category, etc. The programming may score each video in a video list based on the channel theme using the video metadata and user's actions. Videos may be slotted for playback based on the score received. In some embodiments, the score may include a random component to introduce novelty and variety into the channel. The channel may be further refined by AI that adds or removes videos from the channel by taking into account previous actions of the user, such as, changing a channel during a video, skipping a video, selecting a video during search, number of views of a videos, etc.

The video streaming system may include an ordered list of channels. Some of the channels may be free channels that the user may begin watching upon changing to that channel. Other channels may be subscription channels that only may be viewed upon agreeing to pay the subscriber fee. When a user changes to an unsubscribed channel, the unsubscribed channel may display previews, such as video excerpts, or other content to encourage the user to subscribe. Additionally, the user may be provided a button or gesture to trigger a subscription to the channel and begin viewing content.

In a preferred embodiment, there is a default core channel in the list of channels that the user is first directed to when starting the video streaming system. The other channels in the list of channels are present above or below the core channel in the list. Channels may be reordered to reflect the user's viewing habits. In an embodiment, channels that a user frequently views or currently subscribes to are moved to the center of the list around the core channel providing easy access to channels the user is expected to view upon starting the video streaming system. Channels may be reordered based on any of the actions of a viewer, such as, the channels watched, the videos watched, the videos the user skips, the video the user selects, etc. To avoid confusing the user due to the reordering, channels may display a central channel ID when a channel is changed too, so the user may be notified of name of the current channel.

A channel screen may be provided to permit the user to access all the channels. In an embodiment, the channel strip will be a transparent user interface that contains all the channels represented as text or icons. The channel representations may be ordered as a strip or a matrix of channels. The channel representations may be placed in multiple pages or a scrollable strip to permit the user to move through all the channels quickly.

Similarly, in some embodiments, the video viewing system may include a video browse mode that allows the user to browse or search the videos queued for playback in a channel. The video browse mode may be a horizontally scrollable strip of video representations in the queue of the channel. Each video representation may be a representative frame of a video. The video browse mode may display previously viewed videos, the current video before entering the video browse mode, and a future history of scheduled videos for the channel. The user may select a video from the video channel search mode for viewing. The video metadata of each skipped video and the chosen video may be updated to reflect the user's choice for future refinements by the channel script. Upon selecting a video, the video viewing system may enter the focus mode centered around the chosen video. In an embodiment, a video browse action to place the video viewing system into video browse mode may be triggered by a tap and hold gesture, or in other embodiments, by a double finger swipe, a double tap gesture, a tap gesture, etc.

Various gestures may be used by the video streaming system to trigger various actions. To perform the swipe down gesture, the user may place a finger on a point on the touch screen of the video streaming system and drag his or her finger towards the bottom portion of the touchscreen. Conversely, to perform the swipe up gesture, the user may place a finger on a point on the touch screen of the video streaming system and drag his or her finger towards the top portion of the touchscreen. Similarly, to perform the swipe right gesture, the user may place a finger on a point on the touch screen of the video streaming system and drag his or her finger towards the right portion of the touchscreen. Finally, to perform the swipe left gesture, the user may place a finger on a point on the touch screen of the video streaming system and drag his or her finger towards the left portion of the touchscreen.

In one example, as the user performs the channel up or channel down gesture, the frame of the current channel moves off the screen while the frame of the next channel moves onto the screen. The motion of the frame of the current channel and the motion of the frame of the next channel may reflect the motion of the user's finger while making the gesture. For example, if the user stops the gesture before the channel change complete, the motion of the frames may stop to reflect the gesture. Likewise, if the user reverses the gesture before the channel change is complete, the motion may reverse in accordance with the gesture. Each frame representing a channel during a channel up action or a channel down action may be labeled with a central channel ID, that is, the name of the channel superimposed onto the frame representing the channel.

The user may be presented with various controls to manage playback. In an embodiment, a play/pause toggle button is present to pause or restart video playback. Additionally, a progress bar may be provided to show the current location of playback, and the amount of buffered video available. In some embodiments, the user may be able to navigate to various points in the video by clicking on the corresponding location on the progress bar. Further, in some embodiments, a settings button may be provided to permit the user to access the settings of the video streaming system.

As noted, the video streaming system may operate in conjunction with a remote server. The remote server may stream videos to the video streaming system. Additionally, the remote server may execute the channel logic and user logic used to determine the video stream of the channels. The video streaming system may alert the remote server of user actions, such as performing a next action, changing channels, entering focus mode, exiting focus mode, etc. In some embodiments, a user may use the video streaming system to upload video to the remote server.

In an embodiment, a user may be permitted to upload a video to remote server by submitting a link to the video as hosted on the Internet. The remote server may forward the link to a reviewer who may then decide whether to include the video in the remote server's video database. If the video is approved, the user may be given a virtual token that may be used to upload the video to the remote server. The remote server may then incorporate the video into appropriate channels.

In an embodiment, a video streaming system for playback of videos includes: a touch screen display defining a playback window; a processor; and non-transitory computer-readable media including instruction that when executed by the processor cause it to: play one or more videos from a current channel of two or more channels, wherein each channel is a simultaneously available but different feed of videos, and wherein the two or more channels are ordered such that for each channel defines at least one of a previous channel and a next channel; receive a directional input through the user interface; determine whether the user has imparted a predetermined gesture on the touch screen display within the playback window along one of a horizontal axis and a vertical axis defined by an orientation of the one or more videos; and if predetermined gesture is along the vertical axis, updating the current channel of the video media.

In some embodiments, the predetermined gesture is at least one of a swipe up gesture and a swipe down gesture. Additionally, in some embodiments, the step of updating the current channel of the video media updates the current channel to the previous channel when the predetermined gesture is a swipe down gesture, and wherein the step of updating the current channel of the video media updates the current channel to the next channel when the predetermined gesture is a swipe up gesture.

In some embodiments, the non-transitory computer-readable media includes further instruction that when executed by the processor cause it to: if predetermined gesture is along the horizontal axis, performing an action from the group of actions including: playing a next video in the feed of videos of the current channel; and playing one or more videos of a feed of videos selected using a characteristic associated with a video in playback upon receipt of the input defining the predetermined gesture. For example, in some embodiments, the characteristic is selected from the group including artist of the video, television program, popularity, genre, actor in the video, and director.

In some embodiments, if the predetermined gesture is a right swipe action then performing from the group of actions the action of: playing a next video in the feed of videos of the current channel. Likewise, in some embodiments, if the predetermined gesture is a left swipe action then performing from the group of actions the action of: playing one or more videos of a feed of videos selected using a characteristic associated with a video in playback upon receipt of the input defining the predetermined gesture.

In some embodiments, the non-transitory computer-readable media includes further instruction that when executed by the processor cause it to: upon receiving an input from the user interface including a distance along a direction, translating a frame of the current video along the direction, wherein a distance the current video frame is translated is proportional to the distance of the input.

In an embodiment, a video streaming system for playback of videos includes: a processor; a display through which the processor causes a video to display; a user input mechanism in communication with the processor that receives direction commands from a user; a communications module in communication with the processor; wherein the communications module receives two or more simultaneously available unique video feeds, the two or more simultaneously available unique video feeds are ordered such that for each video feed of the two or more simultaneously available unique video feeds there is defined at least one of a next video feed and a previous video feed, and in response to a directional command along the vertical axis, the processor switches the current channel to one of the next video feed and the previous video feed.

An object of the invention is to provide a solution to complex methods of finding video content.

An object of the present invention is to bring the intuitiveness of television watching and “channel surfing” to mobile devices of users.

Another object of the invention is to provide a solution to provide mobile video controls compatible with chained device viewing.

An advantage of the invention is that it provides simple, easy-to-use, intuitive user interfaces for navigating video content on a mobile device.

Another advantage of the invention is that it provides a user interface for use when streaming video from a mobile device to a television.

A further advantage of the invention is that it provides video streaming channels that adapt to the user's tastes and interests.

Yet another advantage of the invention is that it permits a user to view additional content related to content that a user enjoys by “focusing” on that content.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 schematically illustrates an example of a video streaming system ecosystem.

FIG. 2 is a schematic block diagram representation of an example implementation of a embodiment of the video streaming system embodied in a mobile device.

FIG. 3 is a flowchart of an example video streaming method executed by the video streaming system according to the teachings provided herein.

FIG. 4 is a front view of a mobile device illustrating various gestures that may be performed by a user of the mobile device of the video streaming system.

FIG. 5a illustrates a frame of an example video during playback upon entering focus mode.

FIG. 5b illustrates a frame of an example animation during a swipe up gesture.

FIG. 5c illustrates a frame of an example animation during a left swipe gesture.

FIG. 6 illustrates a user interface including various controls to manage playback.

FIG. 7 illustrates a channel screen may be provided to permit the user to browse the channels.

FIG. 8 illustrates a user interface of a video browse mode that may be provided to permit the user to browse the videos of a channel.

### DETAILED DESCRIPTION OF THE INVENTION

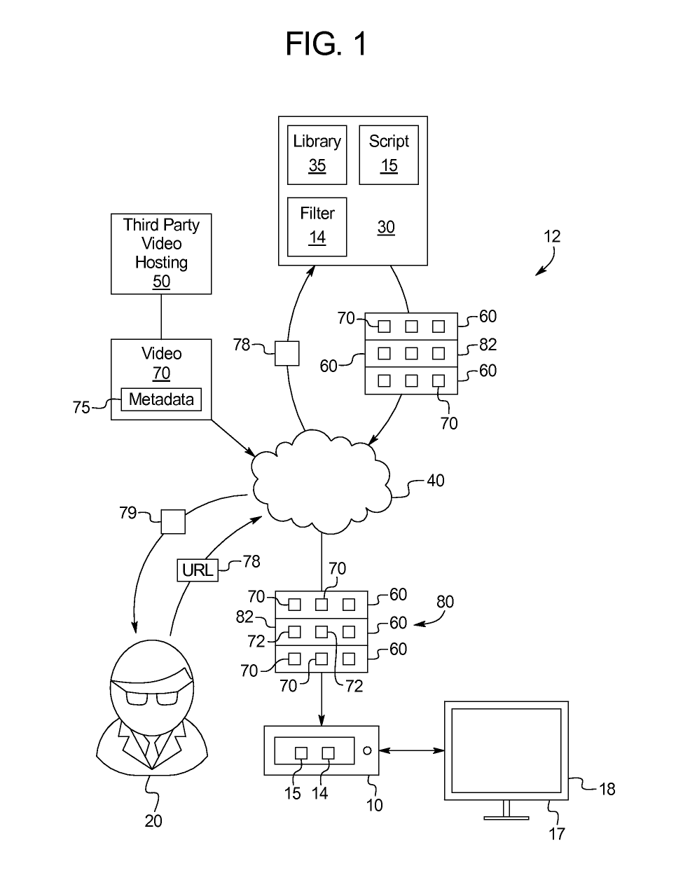

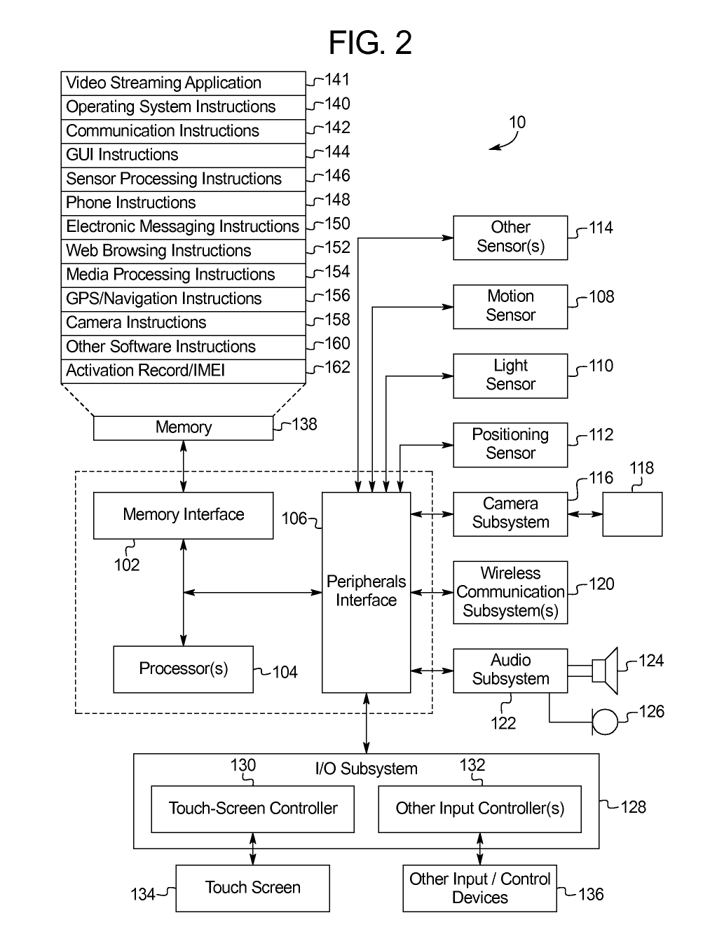

FIG. 1 illustrates an example of the ecosystem of a video streaming system 12 for consuming streaming videos 70 streamed from a remote server 30 or third-party video host 50. The video streaming system 12 may be embodied in a mobile device 10 that includes the functionality described herein, whether hardware or software, such as the video streaming application 141 shown in FIG. 2. The video streaming application 141 may be embodied as instructions stored on non-transitory computer-readable memory 138 and executed by the mobile device 10 of the user 20. In order to accomplish the functionality described herein, the mobile device 10 may communicate with a server 30 over a network 40 to carry out any of the functionality described herein. In other embodiments, the video streaming system 12 may be provided as a tablet device, smart tv, game console, set-top box, etc.

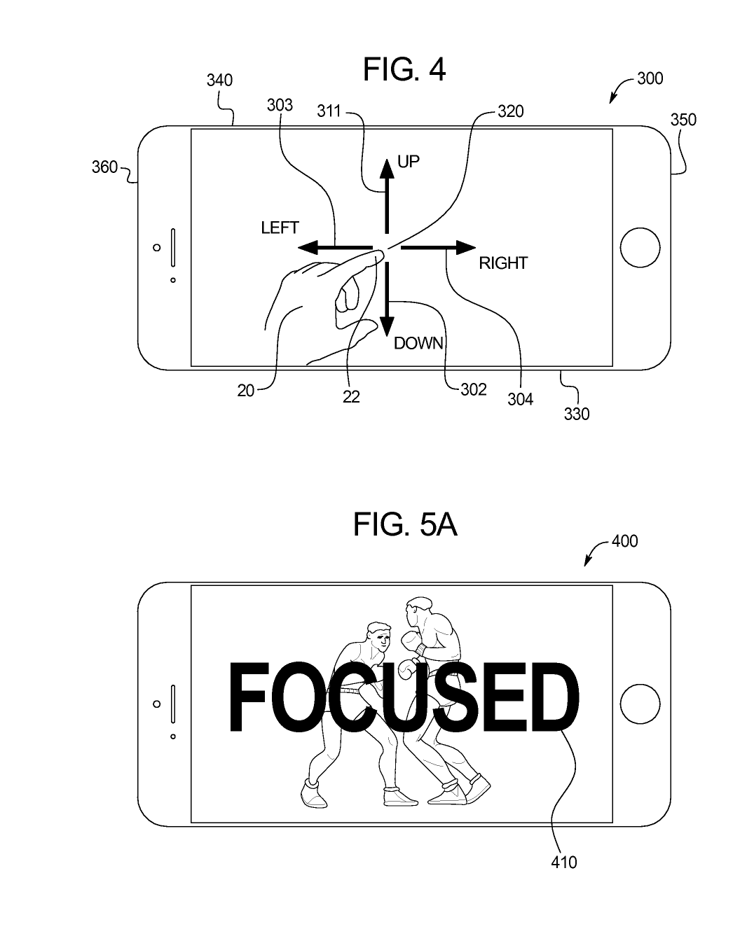

In an embodiment, the video streaming system is a video streaming application 141 that plays streaming videos 20 organized into channels 60. Videos 20 may include music videos, TV episodes, news videos, web clips, movies, etc. Like television, the channels 60 of the video streaming system 12 are generally ordered in a list of channels 80. Thus, a user 20 may easily move through the list of channels 80 by using channel up action 311 and channel down action 312 (FIG. 4). To provide a more television-like appearance, the video streaming application 141 may be adapted to preferably play videos 20 in fullscreen, landscape mode. The video streaming system 12 may include a user interface 17 for displaying the videos 20. The user interface 17 may be provided as a touch screen 134 or a remotely controlled interface such as a television 18, computer monitor, etc.

As noted, like television, the video streaming application 141 permits users 20 to watch a stream of videos 72 that are played consecutively and continuously. However, unlike television, channels 60 do not need to be pre-programmed and may be generated on demand for each user 20 from a video library 35. The video streaming application 141, or the remote server 30, may assemble the channels 60 from a video library 35 using scripts 15 and stream each video 72 to the video streaming system 12 or retrieve a link to stream the video 72 from a third-party video host 50. Alternatively, the mobile device 10 may assemble channels 60 based on video metadata 75 using scripts 15. The video library 35 may include links to videos 20 streamed from a third-party video host 50. For example, the video library 35 may include links to content hosted on third-party video hosts 50, such as Youtube or Vimeo.

A channel 60 is assembled based on a channel programming that determines an ordered stream of videos 70 for playback based on the channel theme. Channel programming for a channel 60 may be provided as a filter 14 or a script 15 that selects videos 70 from a video library 35 based on video metadata 75. Video metadata 75 may include: previous views by the user, views by other users, user actions associated with the video, video tags, title, program, subject, artist, category, etc. For example a script 15 may score each video 70 in the video library 35 using the video metadata 75. Videos 70 may be slotted for playback based on the score received. In some embodiments, the score may include a random component to introduce novelty and variety into the channel 60. For example, the script 15 may score each video 70 in the video library 35 and then add a different random value to each score. The script 15 may then order the videos 70 for playback from the highest to the lowest score. Additionally, the channel 60 may be further refined by artificial intelligence, machine learning, etc., that adds or removes videos 70 from the channel 60 by taking into account previous actions of the user 20 that may be stored in the video metadata 75, such as, changing a channel 60 during a video 70, skipping a video 70, selecting a video 70 during search, number of views of a videos 70, etc.

The video streaming system 12 may include an ordered list of channels 80. Some of the channels 60 may be free channels 60 that the user 20 may begin watching upon changing to that channel 60. Other channels 60 may be subscription channels 60 that only may be viewed upon agreeing to pay a subscriber fee. When a user 20 changes to an unsubscribed channel 60, the unsubscribed channel 60 may display previews, such as excerpts of video 70, or other content to encourage the user 20 to subscribe. Additionally, the user 20 may be provided a button or gesture 300 to trigger a subscription to the channel 60 and begin viewing content.

In a preferred embodiment, a user 20 may be directed to a default core channel 82 of the list of channels 80 when starting the video streaming system 12. The other channels 60 in the list of channels 80 are ordered above or below the core channel 82 in the list of channels 80. Channels 60 may be reordered to reflect the user's viewing habits.

In an embodiment, channels 60 that a user 20 frequently views or is currently subscribed to are moved to the center of the list of channels 80 around the core channel 82 providing easy access to channels 60 the user 20 is expected to view upon starting the video streaming system 12. Channels 60 may be reordered based on any of the actions of the user 20, such as, the channels watched, the videos watched, the videos the user skips, the video the user selects, etc, as reflected in the video metadata 75. User actions when viewing a channel 60 may contribute to a score for that channel 60. For example, each watched video may increase the score by one and each skipped video may decrease the score by one. The channels 60 may then be periodically reordered to reflect each channels 60 current score. For example, the top two scoring channels 60 may be placed around the core channel 82, with the next two top scoring channels 60 on either side of the top two scoring channels, and so on, until every channel is ordered in the list of channels 80. Alternatively, in another embodiment, the channels may be ordered in a list of channels 80 that decreases from the highest to the lowest scoring channel, or ascends from the lowest scoring channel to the highest. To avoid confusing the user 20 due to the reordering, channels 60 may display a central channel ID 410 when a channel becomes active, so the user 20 may be notified of name of the current channel 60.

As shown in FIG. 4, a user 20 may perform various gestures 300. To perform a swipe down gesture 302, the user 20 may place a finger 22 on a point 320 on the touch screen 134 of the video streaming system 12 and drag his or her finger 22 towards the bottom portion 330 of the touch screen 134. Conversely, to perform the swipe up gesture 301, the user 20 may place a finger 22 on a point 320 on the touch screen 134 of the video streaming system 12 and drag his or her finger 22 towards the top portion 340 of the touch screen 134. Similarly, to perform the right swipe gesture 304, the user 20 may place a finger 22 on a point 320 on the touch screen 134 of the video streaming system 12 and drag his or her finger 22 towards the right portion 350 of the touch screen 134. Finally, to perform the left swipe gesture 303, the user 20 may place a finger 22 on a point 320 on the touch screen 134 of the video streaming system 12 and drag his or her finger 22 towards the left portion 360 of the touch screen 134.

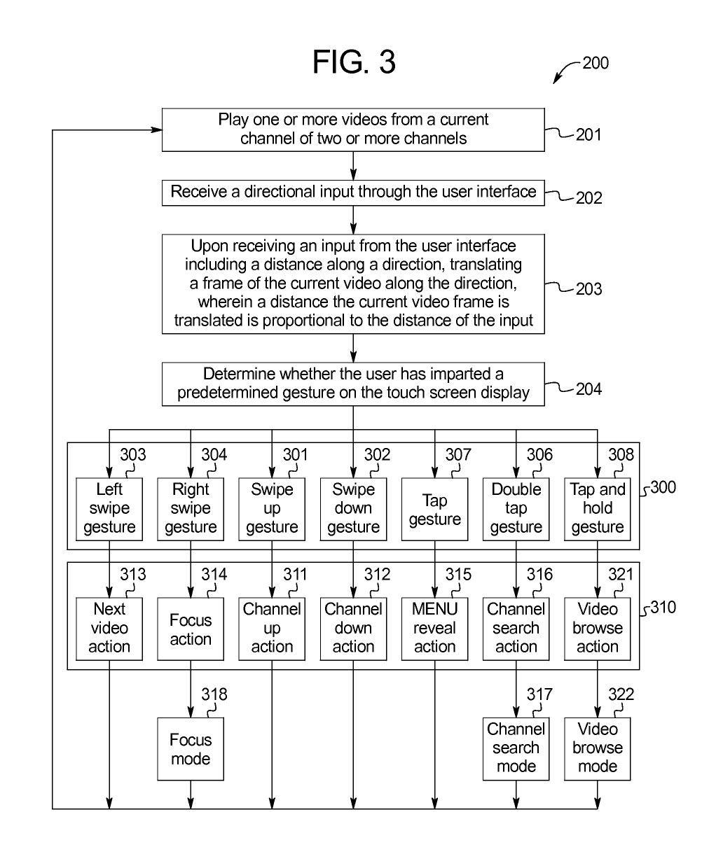

Each gesture 300 may direct the video streaming system 12 to perform various actions 310 to control playback as described in the video streaming method 200 of FIG. 3. For example, in an embodiment, a channel up action 311 and a channel down action 312 are provided to permit the user 20 to move up and down through the available channels 60. In a preferred embodiment, the user 20 may perform a swipe up gesture 301 to trigger the channel up action 311. Likewise, the user 20 may perform a swipe down gesture 302 to trigger the channel down action 312. In other embodiments, the channel up action 311 and channel down 312 action may be associated with alternative gestures 300, such as a double finger swipes 305 left swipe gesture 303, right swipe gesture 304, double tap gesture 306, tap gesture 307, tap and hold gesture 308, etc., as will be recognized by those of ordinary skill in the art from the examples provided herein.

As another example, in an embodiment, a next video action 313 is provided to jump to the next video 72. In a preferred embodiment, a user 20 may trigger a next video action 313 using a left swipe gesture 303. Visually, the left swipe gesture 303 appears to drag the frame 400 of the video 72 to the left, moving the current video 72 off the user interface 18 and the next video 72 onto the user interface 18. In alternate embodiments, alternative gestures 300, such as double finger swipes, a swipe up gesture 301, a swipe down gesture 302, right swipe gesture 304, etc., may be used to trigger the next video action 313, as will be recognized by those of ordinary skill in the art from the examples provided herein. Between videos 72, a still image or bump may be shown while the next video 72 is buffered.

As a further example, in an embodiment, a focus action 314 is provided to place the video streaming system 12 in focus mode 318 wherein playback centers around the video 72 being viewed when the video streaming system 12 receives the focus action 314. For example, in focus mode 318, the video streaming system 12 may show only videos 72 from the particular artist or program that the current video 72 is an episode of. Further, in other examples, other attributes of a video 72 such as popularity, genre, actor, director, etc., may be used to select videos 72 for inclusion in playback during focus mode 318.

In an embodiment, upon being placed in focus mode 318, the video streaming system 12 may retrieve video metadata 75 of the current video 72. The metadata 75 may be passed to a script 15 that may select videos 70 from the video library 35 that have one or more matching pieces of metadata 75. The selected videos 70 may then each be scored based on the match between the metadata 75 of each selected video 70 the current video metadata 75. The script 15 may then order the videos 70 for playback in focus mode 318 from the highest to the lowest score.

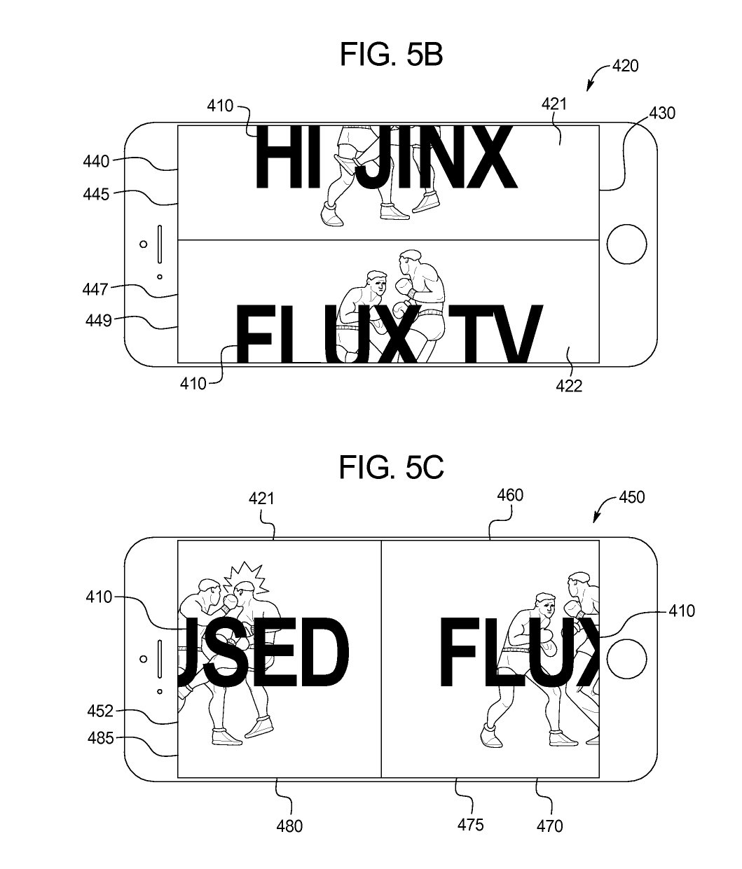

In a preferred embodiment, a right swipe gesture 304 triggers the focus action 314 and puts the video streaming application 141 into focus mode 318. As an example of the focus mode 318 in operation, if the current video 72 is a music video from the user's favorite artist, the user 20 may make a right swipe gesture 304 to put the video streaming system 12 in focus mode 318 and cause the video streaming system 12 to play other music videos 70 from the same artist after the completion of the current video 71. Likewise, if the current video 71 is a favorite show of the user 20, the user 20 may make a right swipe gesture 304 to put the video streaming system 12 in focus mode 318 and cause the video streaming system 12 to play further episodes from the same program. In a preferred embodiment, to leave focus mode 318, the user 20 may make a left swipe gesture 303 and the video streaming system 12 will return to the channel being viewed when focus mode 318 was activated. Further, in a preferred embodiment of the focus mode 318, the user 20 may make a right swipe gesture 304 to bring up the next video 20 of the focus mode 318. In other embodiments, other gestures 300 may be used to trigger the focus mode 318, for example, a double finger swipe 305 may be used to trigger the focus mode. FIG. 5a illustrates a frame 400 of a current video 71 when the video streaming system 12 is placed in focus mode 318. The frame 400 includes a central channel ID 410 that identifies the video streaming system 12 has been placed into focus mode 318.

FIG. 5b illustrates a frame 420 of an example animation 430 during a channel up action 311. As shown, as the user 20 performs a swipe up gesture 301, the frame portion 440 of the current channel 445 moves off the top edge 421 of the touch screen 134 and a frame portion 447 from the next channel 449 moves onto the touch screen 134 from the bottom edge 422 of the frame 420. The animation 430 may reflect the motion of the user's finger 22 while making the gesture 300. For example, if the user 20 stops the gesture 300 without removing his or her finger 22 from the touch screen 134 before the channel change is complete, the animation 430 may stop in the middle of the channel change to reflect the gesture 300. Likewise, if the user 20 reverses the gesture 300 before the channel change is complete, the animation 430 may reverse in accordance with the gesture 300. During the animation 430, the channel 60 may be labeled with a central channel ID. For a channel down action 312, the animation 430 may occur in reverse as will be understood by one of ordinary skill in the art.

FIG. 5c illustrates a frame 450 of an example animation 460 during a right swipe gesture 304 to activate the focus mode 318. As shown, as the user 20 performs a right swipe gesture 304, the frame portion 470 of the current channel 475 moves off the right edge 451 of the frame 450 and a frame portion 480 from the focus mode channel 485 moves into the frame 450 from the left edge 452 of the frame 420. As previously described, the animation 460 may reflect the motion of the user's finger 22 while making the right swipe gesture 304. Similarly, for a left swipe gesture 303, the animation 460 may occur in reverse as will be understood by one of ordinary skill in the art.

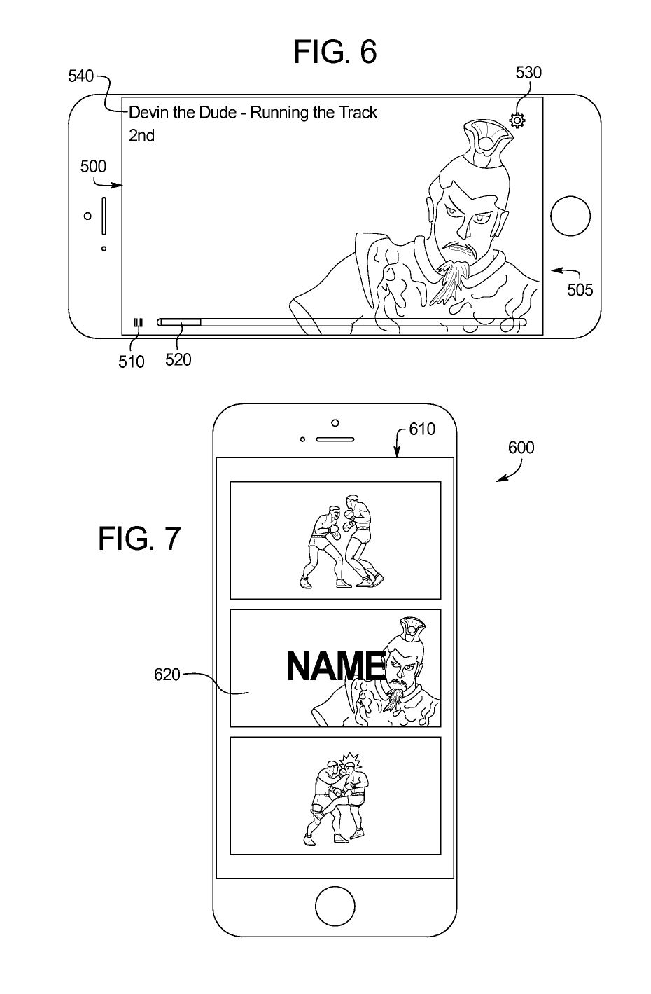

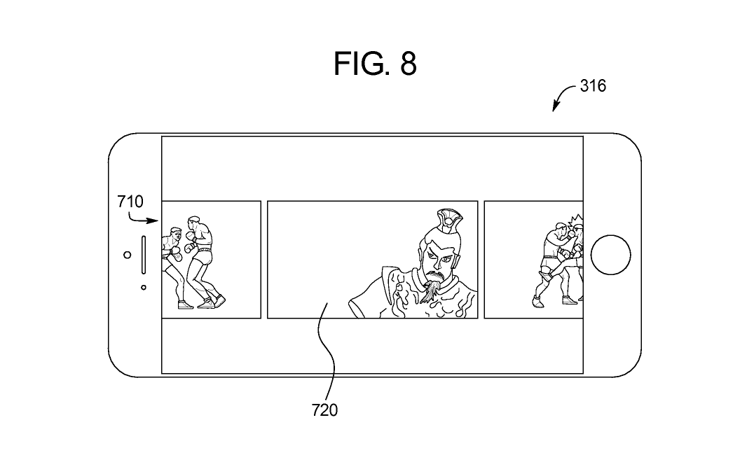

As shown in FIG. 6, the user 20 may be presented with various controls 505 to manage playback. FIG. 6 illustrates a frame 500 of an example video 70 during playback with the controls 505 visible. In the embodiment shown, a play/pause toggle button 510 is present to pause or restart video playback. Additionally, a progress bar 520 may be provided to show the current location of playback and the amount of buffered video available. In some embodiments, the user 20 may be able to navigate to any point in the video 70 by clicking on the corresponding point on the progress bar. Further, in some embodiments, a settings button 530 may be provided to permit the user to access the settings of the video streaming system. Even further, video information 540 may be displayed, such as the title of the video, artist, current channel, etc. Each or all of the play/pause toggle button 510, progress bar 520, settings button 530, and video information 540 may be kept hidden until revealed by a gesture 300 that triggers the menu reveal action 315, such as, a double tap gesture, swipe up gesture 301, swipe down gesture 302, left swipe gesture 303, right swipe gesture 304, etc.

As shown in FIG. 7, a channel screen 600 of a channel search mode 317 may be provided to permit the user 20 to browse all the channels 60. In an embodiment, the channel screen 600 includes a transparent user interface 620 containing channel representations 620, such, as text or icons. The channel representations 620 may be ordered as a strip or a matrix of channels 60. In the embodiment shown, the user 20 may scroll along a vertical channel strip 610 using swipe up gestures 301 and swipe down gestures 302. In the example shown, the channel strip 610 includes vertically ordered channel representations 620 that may span multiple pages or may be scrollable to permit the user 20 to move through all the channel representations 620 quickly. In other embodiments, the user 20 may scroll along a horizontal channel strip 610 using left swipe gestures 303 and right swipe gestures 304. In a further embodiment, the channel representations 620 may be ordered as a matrix of rows and columns from which the user 20 may choose using gestures 300 such as tapping, swiping, etc. In an embodiment, a channel search action 316 to place the video streaming system 12 into channel search mode 317 may be triggered by a double tap gesture 306, or in other embodiments, by a double finger swipe 305, a tap gesture 307, a tap and hold gesture 308, etc.

Similarly, in some embodiments, as shown in FIG. 3, the video streaming system 12 may include a video browse mode 322 that allows the user 20 to browse or search the videos 70 queued for playback in a channel 60. The video browse mode 322 may be a horizontally scrollable video strip 710 of video representations 720 in the queue of the channel 60. Each video representation 720 may be represented by a frame 400 of the video 70. The video browse mode 322 may display previously viewed videos 70, the current video 70 before entering the video browse mode 322, and a future history of scheduled videos 70 for the channel. The user 20 may select a video 70 from the video channel search mode for viewing. The video metadata 75 of each skipped video 70 and the chosen video 70 may be updated to reflect the user's choice for future refinements by the channel script 15. Upon selecting a video 70, the video streaming system 12 may enter the focus mode 318 centered around the chosen video 70. In an embodiment, a video browse action 321 to place the video streaming system 12 into video browse mode 322 may be triggered by a tap and hold gesture 308, or in other embodiments, by a double finger swipe 305, a double tap gesture 306, a tap gesture 307, etc.

In an embodiment, instead of a video browse mode 322, the video streaming system 12 may include a favorites mode. In the favorites mode, videos 72 may be favorited by performing a double tap gesture 306 while a video 72 is playing. Upon receiving the double tap gesture 306, the video 72 may be overlaid with centrally placed text, similar to the central channel ID 410, noting that the video 72 has been “Saved.” The video information 540 may be colored red to indicate to the user 20 that the video 72 has been added to the favorites. To access the saved favorites, the user may perform a tap and hold gesture 308. The central channel ID 410 may include the text “Favorites.” While in the favorites mode, the user 20 may be permitted to perform left swipe gestures 303 and right swipe gestures 304 to move through the favorite videos. To return to the channel 60 or focus mode 318, the user may perform a second tap and hold gesture 308.

In some embodiments, channels 60 (and focuse mode 318) may include product videos 72 incorporated into the video stream. The product videos 72 may advertise products and services for sale through the video streaming system 12. When a product video 72 is being displayed, the controls 505 may include a purchase button, such as an Apple Pay button. The user 20 may purchase the advertised product by clicking the purchase button. Alternatively, the user 20 may single tap the screen to bring up product information. After a product video 72 is displayed, the video streaming system 12 may return to displaying videos 72 in the normal manner. It is contemplated that product videos 72 may be periodically interspersed with regular channel videos 72 in the manner of commercial advertisements.

As noted, the video streaming system 12 may operate in conjunction with a remote server 30. The remote server 30 may include a processor 104 and a non-transitory computer-readable memory 138 including instruction to perform the functionality described herein. The remote server 30 may include communications subsystems 120 to stream videos 70 to the video streaming system 12 over a computer network 40. Additionally, the remote server 30 may execute the filter 14 or scripts 15 used to queue videos 70 of the channels 60. The video streaming system 12 may alert the remote server 30 of user actions, such as performing a next video action 313, changing channels, entering focus mode 318, exiting focus mode 318, etc. In some embodiments, a user 20 may use the video streaming system 12 to upload video to the remote server 30.

In an embodiment, a user 20 may be permitted to upload a video 70 to remote server 30 by submitting a link 78 to the video as hosted by a third-party video host 50. The remote server 30 may forward the link 78 to a reviewer who may then decide whether to include the video 70 in the video library 35. If the video 70 is approved, the user 20 may be given a virtual upload token 79 that may be used to upload the video to the remote server 30. The remote server 30 may then incorporate the video 70 into appropriate channels 60 for distribution.

Referring back to FIG. 3, shown is an example video streaming method 200 that may be performed by the video streaming system 12 to carry out the functionality described herein. The video streaming method 200 when performed by the video streaming system 12 may cause it to: at step 201, play one or more videos 70 from a current channel 60 of two or more channels 60; at step 202, receive a directional input, such as a gesture 300, through the user interface 18; upon receiving an input from the user interface 18 including a distance along a direction, translate a frame 400 of the current video along the direction, wherein a distance the current video frame 400 is translated is proportional to the distance of the input; and determine whether the user 20 has imparted a predetermined gesture 300 on the touch screen display.

Upon determining whether the user 20 has imparted a predetermined gesture on the touch screen 134, the video streaming system 12 may execute an action 310 determined by the gesture 300. In a preferred embodiment, the left swipe gesture 303 triggers a next video action 313, the right swipe gesture 304 triggers a focus action 314 placing playback in the focus mode 318, a swipe up gesture 301 triggers a channel up action 311, a swipe down gesture 302 triggers a channel down action 312, a tap gesture 307 triggers the menu action 315 exposing the play/pause toggle button 510, progress bar 520, and settings button 530, the double tap gesture 306 may trigger the video channel search mode 316

Referring back to FIG. 2, the mobile device 10 includes a memory interface 102, one or more data processors, image processors and/or central processors 104, and a peripherals interface 106. The memory interface 102, the one or more processors 104 and/or the peripherals interface 106 can be separate components or can be integrated in one or more integrated circuits. The various components in the mobile device 10 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and a positioning sensor 112 (e.g., GPS receiver) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 120, which can include radio frequency receivers and transmitters and/or optical (e.g., infrared) receivers and transmitters. The specific design and implementation of the communication subsystem 120 can depend on the communication network(s) over which the mobile device 10 is intended to operate. For example, the mobile device 10 can include communication subsystems 120 designed to operate over a GSM network, a GPRS network, an EDGE network, a Wi-Fi or WiMax network, and a Bluetooth network. In particular, the wireless communication subsystems 120 may include hosting protocols such that the mobile device 10 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 can include a touch screen controller 130 and/or other input controller(s) 132. The touch-screen controller 130 can be coupled to a touch screen 134. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 can be coupled to memory 138. The memory 138 can include high-speed random access memory and/or non-volatile memory, such as one or more magnetic disk storage devices, one or more optical storage devices, and/or flash memory (e.g., NAND, NOR). The memory 138 can store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 138 may also store communication instructions 142 to facilitate communicating with one or more additional devices, one or more computers and/or one or more servers 75. The memory 138 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 138 may also store other software instructions controlling other processes and functions of the mobile device 10 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 138.

Each of the above identified instructions and applications can correspond to a set of instructions for performing one or more functions described herein. These instructions need not be implemented as separate software programs, procedures, or modules. The memory 138 can include additional instructions or fewer instructions. Furthermore, various functions of the mobile device 10 may be implemented in hardware and/or in software, including in one or more signal processing and/or application specific integrated circuits. Accordingly, the mobile device 10, as shown in FIG. 2, may be adapted to perform any combination of the functionality described herein.

Aspects of the systems and methods described herein are controlled by one or more processors 104. The one or more processors 104 may be adapted run a variety of application programs, access and store data, including accessing and storing data in associated databases, and enable one or more interactions via the device 10. Typically, the one or more processors 104 are implemented by one or more programmable data processing devices. The hardware elements, operating systems, and programming languages of such devices are conventional in nature, and it is presumed that those skilled in the art are adequately familiar therewith.

For example, the one or more processors 104 may be a PC based implementation of a central control processing system utilizing a central processing unit (CPU), memories and an interconnect bus. The CPU may contain a single microprocessor, or it may contain a plurality of microprocessors 104 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory stores at least portions of instructions for execution by the CPU and data for processing in accord with the executed instructions.

The one or more processors 104 may also include one or more input/output interfaces for communications with one or more processing systems. Although not shown, one or more such interfaces may enable communications via a network, e.g., to enable sending and receiving instructions electronically. The communication links may be wired or wireless.

The one or more processors 104 may further include appropriate input/output ports for interconnection with one or more output displays (e.g., monitors, printers, touchscreen 134, motion-sensing input device 108, etc.) and one or more input mechanisms (e.g., keyboard, mouse, voice, touch, bioelectric devices, magnetic reader, RFID reader, barcode reader, touchscreen 134, motion-sensing input device 108, etc.) serving as one or more user interfaces for the processor. For example, the one or more processors 104 may include a graphics subsystem to drive the output display. The links of the peripherals to the system may be wired connections or use wireless communications.

Although summarized above as a PC-type implementation, those skilled in the art will recognize that the one or more processors 104 also encompasses systems such as host computers, servers, workstations, network terminals, and the like. Further one or more processors 104 may be embodied in a device 10, such as a mobile electronic device, like a smartphone or tablet computer. In fact, the use of the term processor is intended to represent a broad category of components that are well known in the art.

Hence aspects of the systems and methods provided herein encompass hardware and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

It should be noted that various changes and modifications to the presently preferred embodiments described herein will be apparent to those skilled in the art. Such changes and modifications may be made without departing from the spirit and scope of the present invention and without diminishing its attendant advantages.

1. A video streaming system for playback of videos, comprising:
a touch screen display defining a playback window;
a processor; and
non-transitory computer-readable media including instruction that when executed by the processor cause it to:
play one or more videos from a current channel of two or more channels, wherein each channel is a simultaneously available but different feed of videos, and wherein the two or more channels are ordered such that for each channel defines at least one of a previous channel and a next channel;
receive a directional input through the user interface;
determine whether the user has imparted a predetermined gesture on the touch screen display within the playback window along one of a horizontal axis and a vertical axis defined by an orientation of the one or more videos; and
if predetermined gesture is along the vertical axis, updating the current channel of the video media.

2. The system of claim 1, wherein the predetermined gesture is at least one of a swipe up gesture and a swipe down gesture.

3. The system of claim 2, wherein the step of updating the current channel of the video media updates the current channel to the previous channel when the predetermined gesture is a swipe down gesture, and wherein the step of updating the current channel of the video media updates the current channel to the next channel when the predetermined gesture is a swipe up gesture.

4. The system of claim 1, wherein the non-transitory computer-readable media includes further instruction that when executed by the processor cause it to:
if predetermined gesture is along the horizontal axis, performing an action from the group of actions including:
playing a next video in the feed of videos of the current channel; and
playing one or more videos of a feed of videos selected using a characteristic associated with a video in playback upon receipt of the input defining the predetermined gesture.

5. The system of claim 4, wherein the characteristic is selected from the group including artist of the video, television program, popularity, genre, actor in the video, and director.

6. The system of claim 4, wherein if the predetermined gesture is a right swipe action then performing from the group of actions the action of:
playing a next video in the feed of videos of the current channel.

7. The system of claim 4, wherein if the predetermined gesture is a left swipe action then performing from the group of actions the action of:
playing one or more videos of a feed of videos selected using a characteristic associated with a video in playback upon receipt of the input defining the predetermined gesture.

8. The system of claim 1, wherein the non-transitory computer-readable media includes further instruction that when executed by the processor cause it to:
upon receiving an input from the user interface including a distance along a direction, translating a frame of the current video along the direction, wherein a distance the current video frame is translated is proportional to the distance of the input.

10. A video streaming system for playback of videos, comprising:
a processor;
a display through which the processor causes a video to display;
a user input mechanism in communication with the processor that receives direction commands from a user;
a communications module in communication with the processor;
wherein
the communications module receives two or more simultaneously available unique video feeds,
the two or more simultaneously available unique video feeds are ordered such that for each video feed of the two or more simultaneously available unique video feeds there is defined at least one of a next video feed and a previous video feed, and
in response to a directional command along the vertical axis, the processor switches the current channel to one of the next video feed and the previous video feed.
